(19) United States
(12) Patent Application Publication
(10) Pub. No.: US 2026/0244055 A1
(43) Pub. Date: Aug. 20, 2026

(54) Method of Manufacturing a Display Device

(71) Applicant: Envisics Ltd, Milton Keynes (GB)

(72) Inventor: Jamieson Christmas, Milton Keynes (GB)

(21) Appl. No.: 19/489,563

(22) PCT Filed: Jun. 19, 2024
(86) PCT No.: PCT/EP2024/067102

§ 371 Date: Dec. 2, 2025

(30) Foreign Application Priority Data
Jun. 22, 2023 (GB) 2309443.6

(51) Int. Cl. G02F 1/1345; G03H 1/22

(52) U.S. Cl. CPC G02F 1/1345; G03H 1/2294

(57) ABSTRACT

There is provided a method of manufacturing a spatial light modulator package, the method comprising the steps of: forming an electrically addressable portion on a first major surface of a substrate, the electrically addressable portion comprising: an electrode layer comprising a plurality of electrodes formed on the first major surface of the substrate; a semiconductor structure; and a plurality of solder portions electrically connected or connectable to the electrode layer via the semiconductor structure The method further comprises forming an optically addressable portion by etching the substrate from a second major surface thereof to expose the plurality of electrodes, the second major surface opposing the first major surface. The method further comprises flip chip bonding the electrically addressable portion to a package substrate, the flip chip bonding comprising aligning each solder portion with an electrical contact portion of the package substrate.

### FIELD

The present disclosure relates to a method of manufacturing an optically addressable electrical component. More specifically, the present disclosure relates to a method of manufacturing a spatial light modulator (such as a liquid crystal on silicon spatial light modulator). Even more specifically, the present disclosure relates to a method of manufacturing a spatial light modulator that is suitable for flip chip bonding, for example because the spatial light modulator is electrically addressable and optically addressable from opposing sides. The present disclosure also relates to a method of packaging a spatial light modulator by flip chip bonding the spatial light modulator on to a package substrate, and to the spatial light modulator and spatial light modulator package per se.

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”, and light detection and ranging, “LiDAR”, for example.

### SUMMARY

Aspects of the present disclosure are defined in the appended independent claims.

In general terms, there is provided a method of manufacturing an optically addressable electrical component, such as a spatial light modulator, that is suitable for flip chip bonding to a substrate. There is also provided corresponding methods for performing flip chip bonding with said electrical component and for a corresponding electrical component/spatial light modulator and electrical component package/spatial light modulator package per se.

There is frequently a need to bond an optically addressable electrical component, such as a spatial light modulator, to a substrate such as a printed circuit board or other carrier. There is also typically a need to electrically connect a large number of electrical contact portions on the optically addressable electrical component to corresponding electrical contact portions, for example electrical contact portions of the substrate, such that the electrical component can be controlled/driven by a system, such as a SLM driver (e.g. Field Programmable Gate Array or Application Specific Integrated Circuit) of a head-up display system. One conventional way of achieving this connection in the context of spatial light modulators is by a wire bonding process. In wire bonding, individual wires are formed and attached at opposing ends to respective pairs of electrical contact portions (one on the spatial light modulator, the other on the substrate or carrier). The inventor have recognised that it would be advantageous to instead use a flip chipping bonding process to electrically connect the optically addressable electrical component/spatial light modulator to a package substrate. For example, the bonds formed in a flip chip process may be more mechanically reliable than those formed by wire bonding and, because flip chip bonds are generally shorter than wire bonding bonds, and they may have improved electrical and thermal performance compared to wire bonds. Furthermore, flip chip bonding may allow for a higher number or density of connections than wire bonding. In flip chip bonding, the electrical connections may typically be provided on a reverse side of the electrical component being bonded such that the bonds are formed on a surface of the electrical component facing the package substrate. This is different to wire bonding where the wire bonds may be formed around at least a portion of the perimeter of the electrical component. The inventors have thus recognised that flip chip bonding advantageously allows for smaller packaging compared to wire bonding.

The inventors have further recognised that flip chip bonds could advantageously provide an improved means to physically mount the optically addressable electrical component/spatial light modulator on a carrier/package substrate. In wire bonding, an electrical component may be mounted and fixed on to a carrier with an adhesive. Any electrical connections are then made separately. For most electrical components, the alignment of the electrical component on the substrate or carrier is not important. All that matters is that the adhesive maintains a reliable physical connection between the two components. However, for optically addressable components such as spatial light modulators, correct alignment is critical. But achieving a desired alignment using conventional adhesive techniques is difficult. The inventors have recognised that, when performing flip chip bonding, the physical connection and electrical connection is achieved simultaneously. For example, when a flip chip bonding comprises forming and reflowing a ball grid array of solder balls or bumps, the electrical component will tend to settle into the correct/desired alignment (for example, such that a normal of an optically addressable portion of the electrical component is parallel to a normal of the package substrate). Thus, the inventors have recognised that flip chip bonding of an optically addressable component, such as a spatial light modulator, is particular advantageous. However, the inventors have also recognised that optically addressable components such as spatial light modulators are typically fabricated in such a way that they are not suitable for flip chip bonding (or, at least, not suitable for benefiting from all of the advantages of flip chip bonding). This is because optically addressable components have more constraints than most electrical components. In particular, whereas most electrical components can be bonded to a package substrate in any orientation, optically addressable components require an optically addressable portion to be able to receive light (e.g. not to be facing the package substrate). Typical fabrication processes of optically addressable components such as spatial light modulators result in the electrical contact portions being on the same side of the component as an optically addressable portion of the component. Thus, it is not possible to “flip” the component during the flip chip process while maintaining the optical addressability of an optical addressable portion of the component.

The inventors have developed an unconventional method of manufacturing an optically addressable electrical component (such as a spatial light modulator, e.g. a liquid crystal on silicon spatial light modulator) that enables the fabrication of components which are electrically addressable and optically addressable on opposing sides or faces of the component. This is synergistic with flip chip bonding processes.

In a first aspect, there is provided a method of manufacturing (or fabricating or assembling) an optically addressable electrical component package. The method is advantageous for manufacturing (or fabricating or assembling) a spatial light modulator package such as a liquid crystal on silicon spatial light modulator. As used herein, a “package” refers to an electrical component bonded to a package substrate. The “packaged” electrical component may comprise further features for achieving further functionality such as physical protection (e.g. encapsulation), electrical insulation or thermal management, even if those features are not specifically described in the present disclosure. However, the focus of the present disclosure is the electrical and/or physical connection of the optically addressable electrical component (in particular, spatial light modulator) to a package substrate, such as a printed circuit board. Advantageously, the flip chip bonding techniques of the present disclosure provide an electrical and physical connection between the electrical component and the package simultaneously.

The method comprises the step of forming (for example, fabricating) an electrically addressable portion of the spatial light modulator on a substrate. The substrate may comprise or consist of silicon. For example, the substate may be a silicon wafer. The silicon wafer may be substantially planar. The substrate may have a substantially quadrilateral (such as square or rectangular) shape. In embodiments, the substrate comprises opposing first and second major surfaces. Each of the first and second major surfaces may have the substantially quadrilateral shape. The substrate may be substantially planar.

The method comprises forming the electrically addressable portion of the spatial light modulator on the first major surface of the substrate. The electrically addressable portion (formed on the first major surface of the substrate) comprises an electrode layer. The electrode layer comprises a plurality of electrodes formed on the first major surface of the substrate. The electrodes may be in contact with the first (e.g. a largest) major surface of the substrate. The electrically addressable portion further comprises a semiconductor structure, such as a CMOS semiconductor (i.e. a semiconductor fabricated using a CMOS fabrication process). The semiconductor structure may comprise electrical circuitry embedded therein.

The electrical circuitry of the semiconductor structure may be electrically connected or connectable to the plurality of electrodes. The electrically addressable portion further comprises a plurality of solder portions. Each of the solder portions is electrically connected or connectable to the electrode layer via the semiconductor structure (for example, via the electrical circuitry embedded in the semiconductor structure).

The method further comprises forming (for example, fabricating) an optically addressable portion of the spatial light modulator.

In some embodiments, forming the optically addressable portion of the spatial light modulator comprises etching the substrate from a second major surface thereof to expose the plurality of electrodes. Etching the substrate from the second major surface may mean that material of the substrate is removed from the second major surface. Thus, an etching apparatus/source (such as a source of gas or plasma) may face the second major surface of the substrate during etching.

In some embodiments, forming the optically addressable portion of the spatial light modulator comprises selecting a transparent substrate (on which the electrically addressable portion is formed). In other words, the substrate may be a substantially transparent substrate. In some embodiments, the substrate may be a sapphire substrate. In some embodiments, the substrate may comprise or consist of synthetic sapphire.

In any case, the spatial light modulator according to method of the present disclosure may be optically addressable on an opposite side to which it is optically addressable. In other words, the optically addressable portion may oppose the electrically addressable portion. For example, in embodiments in which the substrate is etched from the second major surface, the (exposed) electrodes may be optically addressable by light received from that second side (which is an opposite side to the side comprising the electrically addressable portion). In embodiments in which the substrate is substantially transparent, light may be received by the substrate on the second side/from the second major surface. The light may be transmitted through the substrate to the electrodes of the electrode layer. Again, this is a side which opposes the side comprises the electrically addressable portion.

The method may further comprise flip chip bonding the electrically addressable portion to a package substrate. In some embodiments, the flip chip bonding step comprises aligning each solder portion with an electrical contact portion of the package substrate. Some advantages of flip chip bonding (e.g. in comparison to wire bonding) have been described above. Because the electrical component (spatial light modulator) is electrically addressable and optically addressable from opposing sides, it can advantageously be “flipped” such that the electrically addressable portion faces, or is in contact, with the package substrate while the optically addressable portion is exposed. In other words, the optically addressable portion may advantageously receive light. Thus, the electrical component/spatial modulator manufactured according to the present disclosure is synergistic with flip chip bonding.

As used herein, a component/portion being “electrically addressable” means that the respective component/portion can be controlled, manipulated, or interacted with using electrical signals. Such a component/portion may respond to voltage, current, or digital signals to achieve a desired functionality. For example, the electrically addressable portion of the spatial light modulator may be electrically addressable because it is electrically connected to the package substrate via the bonds formed in the flip chip bonding process, the circuitry in the semiconductor structure, and/or the electrodes of the electrode layer. The electrically addressable portion can then be controlled/manipulated with/interacted with using electrical signals, for example to drive each of the plurality of electrodes to have a particular voltage.

As used herein, a component/portion being “optically addressable” means that the component/portion can receive or transmit light. The electrodes may act as mirrors. Thus, the electrodes of the electrode layer may reflect the light. The optically addressable portion may be arranged to receive the light along an optical axis.

In some embodiments, the substrate comprises or consists of a semiconductor such as silicon. The substrate may comprise or consist of a substantially opaque material, such as silicon. Prior to the etching step, the substrate may be substantially continuous. Thus, in the absence of the etching step, the electrodes may not be exposed (i.e. may not be visible when viewing the substrate from the second major surface). In other words, the etching step (to expose the electrodes) may be required such that the electrodes can be optically addressed.

In some embodiments, the flip chip bonding step comprises reflowing the plurality of solder portions. The method may further comprise cooling or otherwise resolidifying the solder portions (after the reflow step).

In some embodiments, the flip chip bonding step further comprises underfilling a gap between the electrically addressable portion and the package substrate. This may be after the reflow and optional cooling steps. The underfill material of the underfilling may comprise a dielectric material.

In some embodiments, forming the electrically addressable portion comprises forming the electrode layer by depositing the plurality of electrodes on the first major surface of the substrate. In some embodiments, forming the electrically addressable portion further comprises fabricating the semiconductor structure on the electrode layer. In some embodiments, fabricating the semiconductor structure comprises a complementary metal-oxide-semiconductor fabrication (CMOS) process. In some embodiments, the CMOS processes comprise forming electrical circuitry electrically connected or connectable to the plurality of electrodes.

In some embodiments, the method further comprises forming (e.g. depositing) the plurality of solder portions. This step may be considered to form part of the step of forming the electrically addressable portion and/or the step of flip chip bonding the electrically addressable portion to a package substrate. In some embodiments, the plurality of solder portions are formed on the semiconductor structure. In some embodiments, the semiconductor structure comprises a plurality of electrical contact portions. In some embodiments, fabricating the semiconductor structure comprises forming the plurality of electrical contact portions, for example in a CMOS process. Each electrical contact portion may be electrically coupled or couplable to the electric circuitry of the semiconductor structure. A solder portion may be formed on each electrical contact portion of the semiconductor structure. The step of forming the plurality of solder portions may comprise forming a ball grid array. Each ball of the ball grid array may be formed/deposited on a respective electrical contact portion of the semiconductor structure. The ball grid array may be or comprise an array of solder bumps or solder balls. In other words, each solder portion may be a solder bump or solder ball.

In some embodiments, the method comprises forming the electrode layer (on the first major surface of the substrate) and then fabricating the semiconductor structure (on the electrode layer) and then forming the plurality of solder portions (on the semiconductor structure). In other words, the electrically addressable portion may comprise the solder portions on top of the semiconductor structure which, in turn, is on top of the electrode layer (which, in turn, is on top of the first major surface of the substrate). In some embodiments, the electrically addressable portion has a substantially layered structure (for example, comprising a solder/ball grid array layer on top of a semiconductor structure layer on top of the electrode layer).

In some embodiments, each of the electrodes is formed of a reflective material, such as aluminium. Thus, when the electrodes are exposed (by the etching), each electrode may form a mirror for light incident thereon.

In some embodiments, the package substrate comprises a ceramic material such as aluminium nitride ceramic. In some embodiments, the package substrate comprises a printed circuit board.

In some embodiments, etching the substrate comprises forming a plurality of channels or tunnels in the substrate, each channel exposing an electrode. Each channel may extend from the second major surface of the substrate to the first major surface of the substrate. Each channel may correspond to/be aligned with a respective electrode.

In some embodiments, the method further comprises applying a mask to the second major surface of the substrate. This may be prior to the step of etching the substrate. The mask may comprise a plurality of apertures. Each aperture may be arranged so as to form one of the channels during the etching process. In other words, each aperture may substantially correspond to/be aligned with a respective electrode. In some embodiments, the method further comprises removing the mask after the step of etching the substrate. In some embodiments, the method further comprises infilling each channel with an electrically conductive material. The electrically conductive material may be the same material that forms each of the plurality of electrodes (e.g. aluminium). After infilling, each of the electrodes may be considered to extend into the respective (adjacent) channel. In other word, each electrode may have been effectively extended by the infilling process. Each (extended) electrode may be considered to fill the respective channel.

In some embodiments, the step of etching the substrate (from the second major surface) may comprise removing the substrate substantially completely such as removing more than 95% of the material. In such embodiments, no mask may be applied to substrate prior to applying the mask.

In some embodiments, the step of forming the optically addressable portion is performed before the flip chip bonding step. In some embodiments, the step of forming or fabricating the optically addressable portion further comprises forming a liquid crystal structure. In some embodiments, the step of forming the liquid crystal structure comprises forming a liquid crystal layer comprising a liquid crystal. The step of forming the liquid crystal structure may comprise forming a first alignment layer. The first alignment layer may be in contact with the liquid crystal layer. The first alignment layer may be in contact with or adjacent to the plurality of electrodes. In particular, the first alignment layer may be in contact with or adjacent to surfaces of the plurality of electrodes that are exposed by the etching step or surfaces of the plurality of electrodes formed by infilling the channels formed in the etching step. In some embodiments, the step of forming the liquid crystal structure may comprise forming a second alignment layer. The second alignment layer may be in contact with the liquid crystal layer. The liquid crystal layer may be (sandwiched) between the first and second alignment layers. In some embodiments, the liquid crystal portion has a substantially layered structure.

In a second aspect, there is provided a method of flip chip bonding an optically addressable electrical component (such as a spatial light modulator) to a package substrate. The method comprises the step of aligning a plurality of solder portions of a spatial light modulator with electrical contact portions of a package substrate. The method further comprises reflowing the solder portions. In some embodiments, the spatial light modulator comprises an electrically addressable portion comprising the solder portions and an optically addressable liquid crystal portion. In some embodiments, the optically addressable portion (of the spatial light modulator) is arranged to receive light on an opposite side of the spatial light modulator to the electrically addressable portion. Specifically, the optically addressable portion may be arranged to receive light on an opposite side of the spatial light modulator to that which comprises the solder portions.

In a third aspect, there is provided an optically addressable electrical component package, such as a spatial light modulator package, manufactured according to the method as defined in the first aspect or the second aspect.

In a fourth aspect, there is a provided an optically addressable electrical component, such as a spatial light modulator, comprising a substrate comprising first and second opposing major surfaces; an electrically addressable portion on the first major surface, the electrically addressable portion comprising an electrode layer comprising a plurality of electrodes, and a semiconductor structure arranged such that the electrode layer is closest to the substrate; and an optically addressable portion on the second major surface, the optically addressable portion comprising a layer of liquid crystal. The substrate comprises a plurality of channels from the first major surface to the second major surface, each channel corresponding to a respective electrode. Each electrode extends into/fills its respective (corresponding) channel in the substrate. The electric component/spatial light modulator is arranged to be electrically addressable from a first side and optically addressable from a second side. The first side opposes the second side.

In some embodiments, the electrically addressable portion further comprises a plurality of solder portions electrically connected or connectable to the electrode layer. In some embodiments, the semiconductor structure is positioned between the plurality of solder portions and the electrode layer.

In a fifth aspect, there is provided a spatial light modulator package comprising the spatial light modulator of fourth aspect attached to/bonded to/optionally flip chip bonded to a package substrate. In some embodiments, each solder portion of the spatial light modulator is secured to a respective electrical contact portion of the package substrate.

In a sixth aspect, there is provided a method of manufacturing a spatial light modulator package. The method comprises the steps of: forming an electrically addressable portion on a first major surface of a substrate, the electrically addressable portion comprising. The electrically addressable portion comprises an electrode layer comprising a plurality of electrodes formed on the first major surface of the substrate; a semiconductor structure; and a plurality of solder portions electrically connected or connectable to the electrode layer via the semiconductor structure. The substrate is substantially transparent. For example, the substrate may be a sapphire substrate and may comprise or consist of synthetic sapphire. The substrate transparent substrate may be arranged such that the substrate is optically addressable from a second major surface opposing the first major surface (on which the electrically addressable portion is formed). In other words, an optically addressable portion of the spatial modulator may be formed (that opposes the electrically addressable portion) based on the selection of a substantially transparent substrate. The method further comprises flip chip bonding the electrically addressable portion to a package substrate, the flip chip bonding comprising aligning each solder portion with an electrical contact portion of the package substrate.

In a seventh aspect, there is provided a spatial light modulator comprising: a substrate comprising first and second opposing major surfaces; an electrically addressable portion on the first major surface, the electrically addressable portion comprising an electrode layer comprising a plurality of electrodes, and a semiconductor structure arranged such that the electrode layer is between the substrate and the semiconductor structure; wherein the substrate is arranged such that the spatial light modulator comprises an optically addressable portion that opposes the electrically addressable portion. In some embodiments, the optically addressable portion comprises a layer of liquid crystal. In some embodiments the substrate comprises a plurality of channels from the first major surface to the second major surface, each channel corresponding to a respective electrode. The plurality of channel may expose the plurality of electrodes such that the plurality of electrodes are optically addressable via the channels (by light received by or from the second major surface of the substrate). In some embodiments, the substrate may be a substantially transmissive substrate such that the plurality of electrodes are optically addressable via the substrate (by light received by or from the second major surface of the substrate and transmitted through the substantially transparent substrate).

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2A illustrates a first iteration of an example Gerchberg-Saxton type algorithm;

FIG. 2B illustrates the second and subsequent iterations of the example Gerchberg-Saxton type algorithm;

FIG. 2C illustrates alternative second and subsequent iterations of the example Gerchberg-Saxton type algorithm;

FIG. 3 is a schematic of a prior art reflective LCOS SLM;

FIG. 4 is a schematic of a prior art reflective LCOS SLM wire bonded to a connector;

FIG. 5 is a flow diagram showing a method of manufacture according to the present disclosure;

FIG. 6 is a cross-sectional view of a first step of the method of FIG. 5 in which a substrate is provided;

FIG. 7 is a cross-sectional view of a second step of the method of FIG. 5 in which a plurality of electrodes have been deposited on to the substrate, thereby forming an electrode layer;

FIG. 8 is a cross-sectional view of an optional third step of the method of FIG. 5 in which gaps between the electrodes have been infilled with a dielectric material;

FIG. 9 is a cross-sectional view of a fourth step of the method of FIG. 5 in which a semiconductor stack has been fabricated on the electrode layer;

FIG. 10 is a cross-sectional view of a fifth step of the method of FIG. 5 in which a mask has been applied to the substrate on a second side of the substrate and in which an etching process is being performed from that second side;

FIG. 11 is a cross-sectional view of a sixth step of the method of FIG. 5 in which etching has been completed such that the electrodes of the electrode are exposed via channels in substrate and the mask has been removed;

FIG. 12 is a cross-sectional view of a seventh step of the method of FIG. 5 in which the channels in the substrate have been infilled with electrically conductive material;

FIG. 13 is a cross-sectional view of an eighth step of the method of FIG. 5 in which a liquid crystal structure has been formed on the second side of the substrate to form a spatial light modulator;

FIG. 14 is a cross-sectional view of a ninth step of the method of FIG. 5 in which a ball grid array of solder balls has been deposited on the semiconductor stack of the spatial light modulator;

FIG. 15 is a cross-sectional view of a tenth step of the method of FIG. 5 in which the spatial light modulator has been flipped and the solder balls have been aligned with corresponding electrical contact portions of the package substrate;

FIG. 16 is a cross-sectional view of the spatial light modulator resting on the package substrate; and

FIG. 17 is a cross-sectional view of an eleventh step of the method of FIG. 5 in which the solder balls have been reflowed and solidified.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

### Optical Configuration

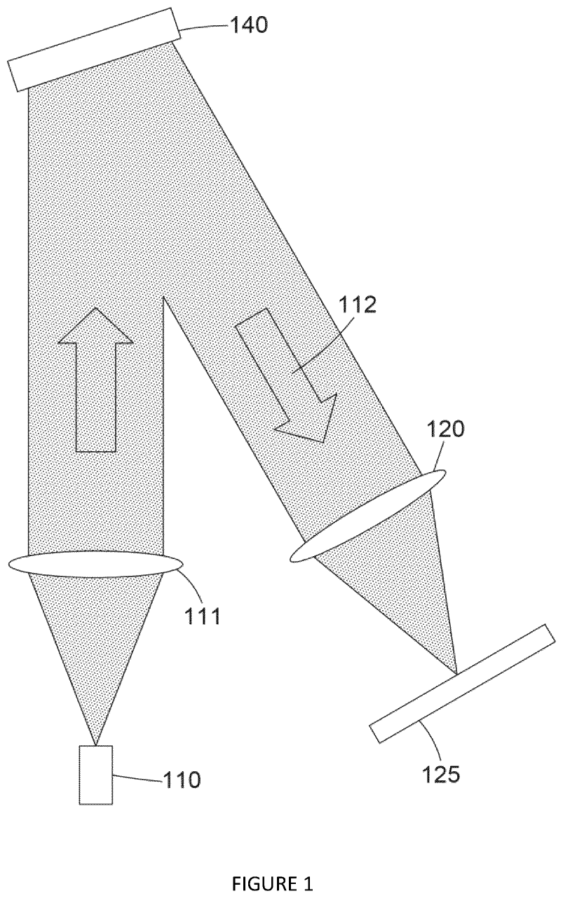

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms.

A Fourier transform hologram may be calculated using an algorithm such as the Gerchberg-Saxton algorithm. Furthermore, the Gerchberg-Saxton algorithm may be used to calculate a hologram in the Fourier domain (i.e. a Fourier transform hologram) from amplitude-only information in the spatial domain (such as a photograph). The phase information related to the object is effectively “retrieved” from the amplitude-only information in the spatial domain. In some embodiments, a computer-generated hologram is calculated from amplitude-only information using the Gerchberg-Saxton algorithm or a variation thereof.

The Gerchberg Saxton algorithm considers the situation when intensity cross-sections of a light beam, I_{A}(x, y) and I_{B}(x, y), in the planes A and B respectively, are known and I_{A}(x, y) and I_{B}(x, y) are related by a single Fourier transform. With the given intensity cross-sections, an approximation to the phase distribution in the planes A and B, YA (x, y) and 4B (x, y) respectively, is found. The Gerchberg-Saxton algorithm finds solutions to this problem by following an iterative process. More specifically, the Gerchberg-Saxton algorithm iteratively applies spatial and spectral constraints while repeatedly transferring a data set (amplitude and phase), representative of I_{A}(x, y) and I_{B}(x, y), between the spatial domain and the Fourier (spectral or frequency) domain. The corresponding computer-generated hologram in the spectral domain is obtained through at least one iteration of the algorithm. The algorithm is convergent and arranged to produce a hologram representing an input image. The hologram may be an amplitude-only hologram, a phase-only hologram or a fully complex hologram.

In some embodiments, a phase-only hologram is calculated using an algorithm based on the Gerchberg-Saxton algorithm such as described in British patent 2,498,170 or 2,501,112 which are hereby incorporated in their entirety by reference. However, embodiments disclosed herein describe calculating a phase-only hologram by way of example only. In these embodiments, the Gerchberg-Saxton algorithm retrieves the phase information ψ[u, v] of the Fourier transform of the data set which gives rise to a known amplitude information T[x, y], wherein the amplitude information T[x, y] is representative of a target image (e.g. a photograph). Since the magnitude and phase are intrinsically combined in the Fourier transform, the transformed magnitude and phase contain useful information about the accuracy of the calculated data set. Thus, the algorithm may be used iteratively with feedback on both the amplitude and the phase information. However, in these embodiments, only the phase information ψ[u, v] is used as the hologram to form a holographic representative of the target image at an image plane. The hologram is a data set (e.g. 2D array) of phase values.

In other embodiments, an algorithm based on the Gerchberg-Saxton algorithm is used to calculate a fully-complex hologram. A fully-complex hologram is a hologram having a magnitude component and a phase component. The hologram is a data set (e.g. 2D array) comprising an array of complex data values wherein each complex data value comprises a magnitude component and a phase component.

In some embodiments, the algorithm processes complex data and the Fourier transforms are complex Fourier transforms. Complex data may be considered as comprising (i) a real component and an imaginary component or (ii) a magnitude component and a phase component. In some embodiments, the two components of the complex data are processed differently at various stages of the algorithm.

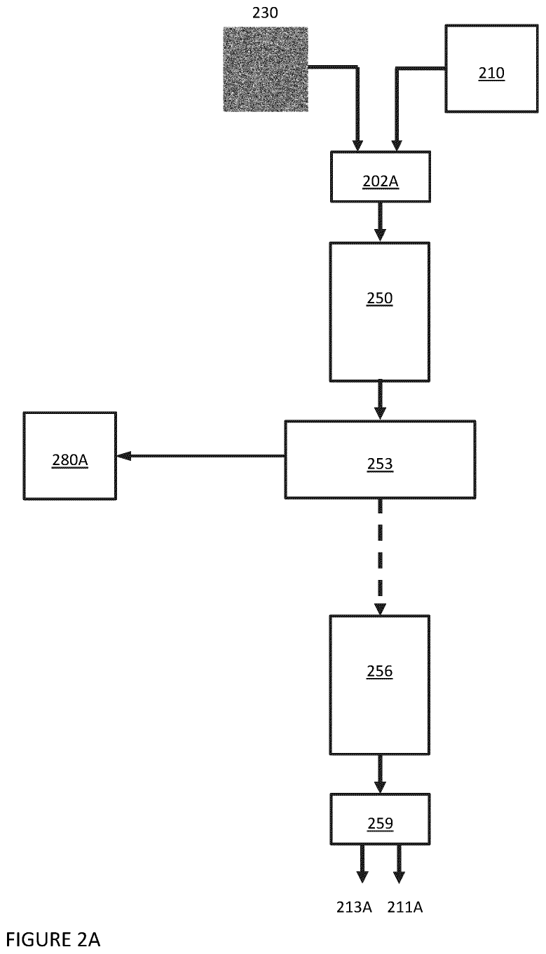

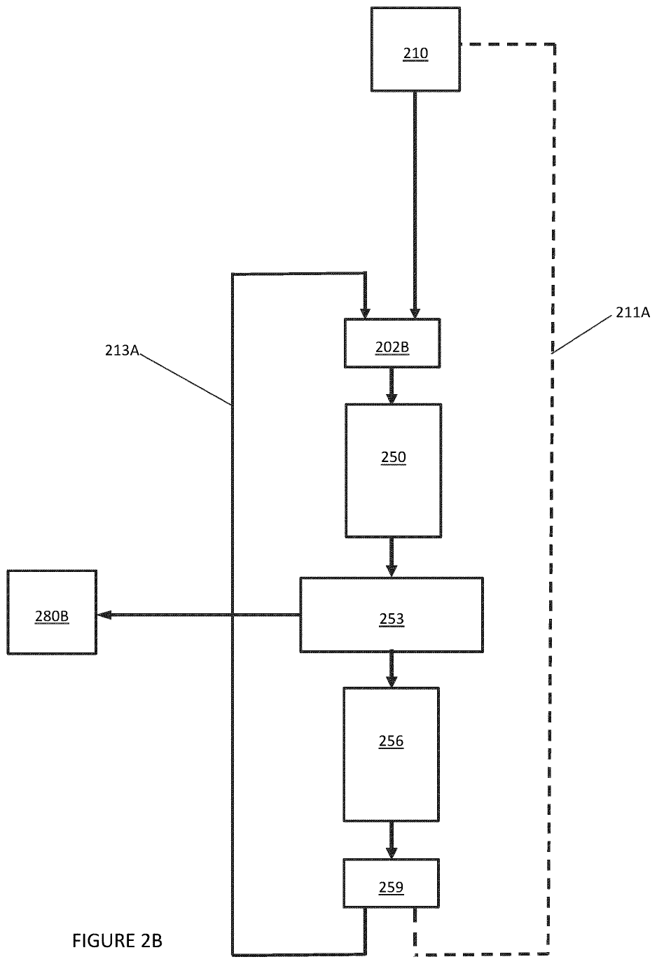

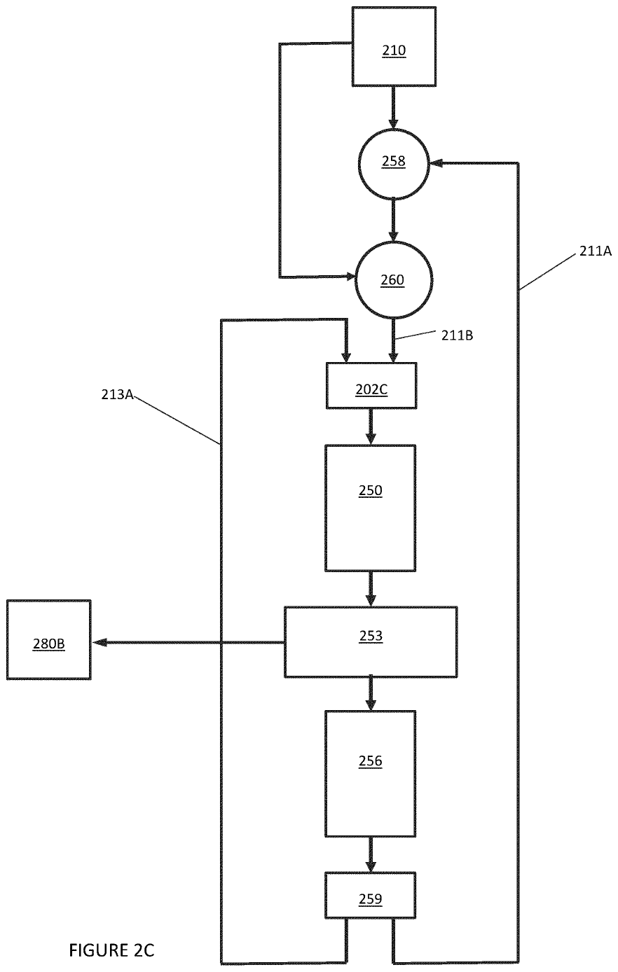

FIG. 2A illustrates the first iteration of an algorithm in accordance with some embodiments for calculating a phase-only hologram. The input to the algorithm is an input image 210 comprising a 2D array of pixels or data values, wherein each pixel or data value is a magnitude, or amplitude, value. That is, each pixel or data value of the input image 210 does not have a phase component. The input image 210 may therefore be considered a magnitude-only or amplitude-only or intensity-only distribution. An example of such an input image 210 is a photograph or one frame of video comprising a temporal sequence of frames. The first iteration of the algorithm starts with a data forming step 202A comprising assigning a random phase value to each pixel of the input image, using a random phase distribution (or random phase seed) 230, to form a starting complex data set wherein each data element of the set comprising magnitude and phase. It may be said that the starting complex data set is representative of the input image in the spatial domain.

First processing block 250 receives the starting complex data set and performs a complex Fourier transform to form a Fourier transformed complex data set. Second processing block 253 receives the Fourier transformed complex data set and outputs a hologram 280A. In some embodiments, the hologram 280A is a phase-only hologram. In these embodiments, second processing block 253 quantises each phase value and sets each amplitude value to unity in order to form hologram 280A. Each phase value is quantised in accordance with the phase-levels which may be represented on the pixels of the spatial light modulator which will be used to “display” the phase-only hologram. For example, if each pixel of the spatial light modulator provides 256 different phase levels, each phase value of the hologram is quantised into one phase level of the 256 possible phase levels. Hologram 280A is a phase-only Fourier hologram which is representative of an input image. In other embodiments, the hologram 280A is a fully complex hologram comprising an array of complex data values (each including an amplitude component and a phase component) derived from the received Fourier transformed complex data set. In some embodiments, second processing block 253 constrains each complex data value to one of a plurality of allowable complex modulation levels to form hologram 280A. The step of constraining may include setting each complex data value to the nearest allowable complex modulation level in the complex plane. It may be said that hologram 280A is representative of the input image in the spectral or Fourier or frequency domain. In some embodiments, the algorithm stops at this point.

However, in other embodiments, the algorithm continues as represented by the dotted arrow in FIG. 2A. In other words, the steps which follow the dotted arrow in FIG. 2A are optional (i.e. not essential to all embodiments).

Third processing block 256 receives the modified complex data set from the second processing block 253 and performs an inverse Fourier transform to form an inverse Fourier transformed complex data set. It may be said that the inverse Fourier transformed complex data set is representative of the input image in the spatial domain.

Fourth processing block 259 receives the inverse Fourier transformed complex data set and extracts the distribution of magnitude values 211A and the distribution of phase values 213A. Optionally, the fourth processing block 259 assesses the distribution of magnitude values 211A. Specifically, the fourth processing block 259 may compare the distribution of magnitude values 211A of the inverse Fourier transformed complex data set with the input image 510 which is itself, of course, a distribution of magnitude values. If the difference between the distribution of magnitude values 211A and the input image 210 is sufficiently small, the fourth processing block 259 may determine that the hologram 280A is acceptable. That is, if the difference between the distribution of magnitude values 211A and the input image 210 is sufficiently small, the fourth processing block 259 may determine that the hologram 280A is a sufficiently-accurate representative of the input image 210. In some embodiments, the distribution of phase values 213A of the inverse Fourier transformed complex data set is ignored for the purpose of the comparison. It will be appreciated that any number of different methods for comparing the distribution of magnitude values 211A and the input image 210 may be employed and the present disclosure is not limited to any particular method. In some embodiments, a mean square difference is calculated and if the mean square difference is less than a threshold value, the hologram 280A is deemed acceptable. If the fourth processing block 259 determines that the hologram 280A is not acceptable, a further iteration of the algorithm may be performed. However, this comparison step is not essential and in other embodiments, the number of iterations of the algorithm performed is predetermined or preset or user-defined.

FIG. 2B represents a second iteration of the algorithm and any further iterations of the algorithm. The distribution of phase values 213A of the preceding iteration is fed-back through the processing blocks of the algorithm. The distribution of magnitude values 211A is rejected in favour of the distribution of magnitude values of the input image 210. In the first iteration, the data forming step 202A formed the first complex data set by combining distribution of magnitude values of the input image 210 with a random phase distribution 230. However, in the second and subsequent iterations, the data forming step 202B comprises forming a complex data set by combining (i) the distribution of phase values 213A from the previous iteration of the algorithm with (ii) the distribution of magnitude values of the input image 210.

The complex data set formed by the data forming step 202B of FIG. 2B is then processed in the same way described with reference to FIG. 2A to form second iteration hologram 280B. The explanation of the process is not therefore repeated here. The algorithm may stop when the second iteration hologram 280B has been calculated. However, any number of further iterations of the algorithm may be performed. It will be understood that the third processing block 256 is only required if the fourth processing block 259 is required or a further iteration is required. The output hologram 280B generally gets better with each iteration. However, in practice, a point is usually reached at which no measurable improvement is observed or the positive benefit of performing a further iteration is out-weighted by the negative effect of additional processing time. Hence, the algorithm is described as iterative and convergent.

FIG. 2C represents an alternative embodiment of the second and subsequent iterations. The distribution of phase values 213A of the preceding iteration is fed-back through the processing blocks of the algorithm. The distribution of magnitude values 211A is rejected in favour of an alternative distribution of magnitude values. In this alternative embodiment, the alternative distribution of magnitude values is derived from the distribution of magnitude values 211 of the previous iteration. Specifically, processing block 258 subtracts the distribution of magnitude values of the input image 210 from the distribution of magnitude values 211 of the previous iteration, scales that difference by a gain factor α and subtracts the scaled difference from the input image 210. This is expressed mathematically by the following equations, wherein the subscript text and numbers indicate the iteration number:

$${R}_{n + 1} [ x , y ] = {F}^{′} \{ exp ( {i ψ}_{n} [ u , v ] ) \}$$

$${ψ}_{n} [ u , v ] = ∠F \{ η \cdot exp ( i ∠ {R}_{n} [ x , y ] ) \}$$

$$η = T [ x , y ] - α ( \vert {R}_{n} [ x , y ] \vert - T [ x , y ] )$$

where:
F′ is the inverse Fourier transform;
F is the forward Fourier transform;
R[x, y] is the complex data set output by the third processing block 256;
T[x, y] is the input or target image;
∠ is the phase component;
ψ is the phase-only hologram 280B;
η is the new distribution of magnitude values 211B; and
α is the gain factor.

The gain factor α may be fixed or variable. In some embodiments, the gain factor α is determined based on the size and rate of the incoming target image data. In some embodiments, the gain factor α is dependent on the iteration number. In some embodiments, the gain factor α is solely function of the iteration number.

The embodiment of FIG. 2C is the same as that of FIG. 2A and FIG. 2B in all other respects. It may be said that the phase-only hologram ψ(u, v) comprises a phase distribution in the frequency or Fourier domain.

In some embodiments, the Fourier transform is performed using the spatial light modulator. Specifically, the hologram data is combined with second data providing optical power. That is, the data written to the spatial light modulation comprises hologram data representing the object and lens data representative of a lens. When displayed on a spatial light modulator and illuminated with light, the lens data emulates a physical lens—that is, it brings light to a focus in the same way as the corresponding physical optic. The lens data therefore provides optical, or focusing, power. In these embodiments, the physical Fourier transform lens 120 of FIG. 1 may be omitted. It is known how to calculate data representative of a lens. The data representative of a lens may be referred to as a software lens. For example, a phase-only lens may be formed by calculating the phase delay caused by each point of the lens owing to its refractive index and spatially-variant optical path length. For example, the optical path length at the centre of a convex lens is greater than the optical path length at the edges of the lens. An amplitude-only lens may be formed by a Fresnel zone plate. It is also known in the art of computer-generated holography how to combine data representative of a lens with a hologram so that a Fourier transform of the hologram can be performed without the need for a physical Fourier lens. In some embodiments, lensing data is combined with the hologram by simple addition such as simple vector addition. In some embodiments, a physical lens is used in conjunction with a software lens to perform the Fourier transform. Alternatively, in other embodiments, the Fourier transform lens is omitted altogether such that the holographic reconstruction takes place in the far-field. In further embodiments, the hologram may be combined in the same way with grating data—that is, data arranged to perform the function of a grating such as image steering. Again, it is known in the field how to calculate such data. For example, a phase-only grating may be formed by modelling the phase delay caused by each point on the surface of a blazed grating. An amplitude-only grating may be simply superimposed with an amplitude-only hologram to provide angular steering of the holographic reconstruction. The second data providing lensing and/or steering may be referred to as a light processing function or light processing pattern to distinguish from the hologram data which may be referred to as an image forming function or image forming pattern.

In some embodiments, the Fourier transform is performed jointly by a physical Fourier transform lens and a software lens. That is, some optical power which contributes to the Fourier transform is provided by a software lens and the rest of the optical power which contributes to the Fourier transform is provided by a physical optic or optics.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

Embodiments relate to Fourier holography and Gerchberg-Saxton type algorithms by way of example only. The present disclosure is equally applicable to Fresnel holography and Fresnel holograms which may be calculated by a similar method. The present disclosure is also applicable to holograms calculated by other techniques such as those based on point cloud methods.

### Light Modulation

A spatial light modulator may be used to display the diffractive pattern including the computer-generated hologram. If the hologram is a phase-only hologram, a spatial light modulator which modulates phase is required. If the hologram is a fully-complex hologram, a spatial light modulator which modulates phase and amplitude may be used or a first spatial light modulator which modulates phase and a second spatial light modulator which modulates amplitude may be used.

In some embodiments, the light-modulating elements (i.e. the pixels) of the spatial light modulator are cells containing liquid crystal. That is, in some embodiments, the spatial light modulator is a liquid crystal device in which the optically-active component is the liquid crystal. Each liquid crystal cell is configured to selectively-provide a plurality of light modulation levels. That is, each liquid crystal cell is configured at any one time to operate at one light modulation level selected from a plurality of possible light modulation levels. Each liquid crystal cell is dynamically-reconfigurable to a different light modulation level from the plurality of light modulation levels.

A LCOS device provides a dense array of light modulating elements, or pixels, within a small aperture (e.g. a few centimetres in width). The pixels are typically approximately 10 microns or less which results in a diffraction angle of a few degrees meaning that the optical system can be compact. It is easier to adequately illuminate the small aperture of a LCOS SLM than it is the larger aperture of other liquid crystal devices. An LCOS device is typically reflective which means that the circuitry which drives the pixels of a LCOS SLM can be buried under the reflective surface. The results in a higher aperture ratio. In other words, the pixels are closely packed meaning there is very little dead space between the pixels. This is advantageous because it reduces the optical noise in the replay field.

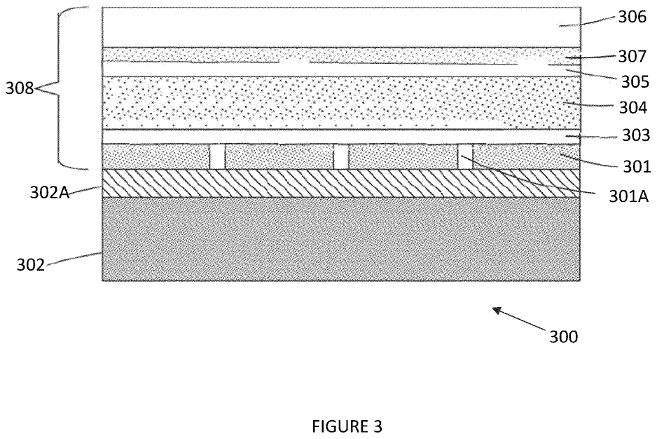

A prior art LCOS SLM that is suitable for displaying (for example) a phase hologram is described below with reference to FIG. 3.

FIG. 3 shows a schematic cross-section view of the prior art LCOS device 300. The LCOS device 300 is formed using a single crystal silicon substrate 302 as a silicon backplane which advantageously provides a flat surface on which to form the pixels of the SLM. CMOS processes have been used to build up a silicon semiconductor stack 302A on the substrate 302. A 2D array of square planar aluminium electrodes 301 are located on top of the silicone semiconductor stack 302. The planar aluminium electrodes 301 are spaced apart by gaps 301a, arranged on the upper surface of the substrate 300/302a. Each of the electrodes 301 can be addressed via circuitry buried in/formed in the semiconductor stack 302A. Each of the electrodes 301 forms a respective planar mirror. An alignment layer 303 is disposed on the array of electrodes, and a liquid crystal layer 304 is disposed on the alignment layer 303. A second alignment layer 305 is disposed on the planar transparent layer 306, e.g. of glass. A single transparent electrode 307 e.g. of ITO is disposed between the transparent layer 306 and the second alignment layer 305.

Each of the square electrodes 301 defines, together with the overlying region of the transparent electrode 307 and the intervening liquid crystal material, a controllable phase-modulating element 308, often referred to as a pixel. The effective pixel area, or fill factor, is the percentage of the total pixel which is optically active, taking into account the space between pixels 301A. By control of the voltage applied to each electrode 301 with respect to the transparent electrode 307, the properties of the liquid crystal material of the respective phase modulating element may be varied, thereby to provide a variable delay to light incident thereon. The effect is to provide phase-only modulation to the wavefront, i.e. no amplitude effect occurs.

The described LCOS SLM outputs spatially modulated light in reflection. Reflective LCOS SLMs have the advantage that the signal lines, gate lines and transistors are below the mirrored surface, which results in high fill factors (typically greater than 90%) and high resolutions. Another advantage of using a reflective LCOS spatial light modulator is that the liquid crystal layer can be half the thickness than would be necessary if a transmissive device were used. This greatly improves the switching speed of the liquid crystal (a key advantage for the projection of moving video images).

### Wire Bonding of an LCOS SLM

The prior art LCOS SLM described above can be manufactured/fabricated, for example, by: a) fabricating the semiconductor stack 302A on the substrate 302 using CMOS process; b) depositing the electrodes 301 on the semiconductor stack 302A to form an electrode layer; c) forming the (first) alignment layer 303 on the electrode layer, for example using a thin-film process; d) applying/forming the liquid crystal layer 304 on the first alignment layer 303; e) forming the (second) alignment layer 305) on the liquid crystal layer 304, for example using a thin-film process; f) depositing the transparent electrode 307 on the second alignment layer 305; and g) sealing the liquid crystal layer 304 using a transparent layer on the transparent electrode 307 and, optionally, with seals around the perimeter of the LCOS SLM (not shown in FIG. 3).

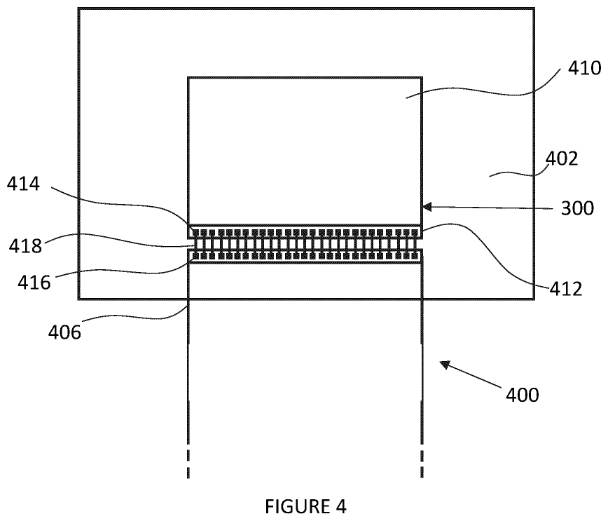

Once the prior art LCOS SLM has been fabricated, there is a need to package the LCOS SLM as a display device. In particular, the LCOS SLM may typically be bonded on to a carrier, such a printed circuit board, and electrical bonds/connections are then made between the LCOS SLM and a connector. Typically, this may be achieved using wire bonds, as shown in FIG. 4.

FIG. 4 shows a schematic top view of a display device 400. The display device 400 comprises a carrier 402, which in this example is a ceramic carrier such as a printed circuit board. The spatial light modulator 300 of FIG. 3 is mounted on the carrier 402. An adhesive layer (not shown in the figures) secures the spatial light modulator 300 to the carrier 402. In particular, the adhesive layer secures the substrate 302 of the spatial light modulator 300 to the carrier 402 of the display device 400. A connector 406 is electrically connected to the spatial light modulator 300. In this example, the connector 406 is a flexible printed cable but may alternatively be a flat flex connector or a flexible printed circuit board. Only an end portion of the connector 406 is shown in FIG. 4. The connector 406 extends from the end portion and away from the spatial light modulator 300. This is represented by the broken lines in FIG. 4. In some embodiments, the other end of the connector 406 (not shown in figures) is connected to another part of a HUD system. In some examples, the connector 406 is directly or indirectly electrically connected to a controller of the HUD system such as a real-time engine arranged to receive image data, calculate holograms in real-time and display the holograms on the spatial light modulator via the connector 406.

The spatial light modulator 300 comprises a light modulating region 410 and an electrical connection region 412 (or wire bond region). From the perspective shown, the light modulating region 410 of FIG. 4 corresponds to the planar transparent glass layer 306 of FIG. 3. The electrical connection region 412 is formed by/on the silicon stack and is used to connect the spatial light modulator 300 to the rest of the HUD system via the connector 406. The electrical connection region 412 comprises a plurality of (in this example, 28, but the present disclosure is not limited thereto) first contact portions 414. Each first contact portion 414 is electrically connected to circuitry 302a described in FIG. 3.

The connector 406 comprises a plurality of second contact portions 416. There is one second contact portion 416 for each first contact portion 414 so, in this example, there are 28 second contact portions 416. Each first contact portion 414 is connected to a respective second contact portion 416 via a wire bond 418 such that there are also 28 wire bonds in this example. In examples, the wire bonds 418 are formed of aluminium doped with silicon. In examples, the wire bonds 418 are formed by wedge bonding.

FIG. 4 shows a display device 400 in which the LCOS 300 is mounted on a carrier 402 and electrically connected to a connector 406. It should be understood that the carrier 402 could instead comprise the second contact portions and that wire bonds may instead be used to connect the first contact portions 414 to the respective second contact portions 416. In such examples, a separate connector 406 may not be provided, although the carrier 406 may comprise another connection region for connecting the carrier (and so, indirectly, the LCOS 300) to the rest of a HUD system, for example.

### Fabricating an LCOS SLM Suitable for Chip Flipping

The inventors have recognised that it would be advantageous for the LCOS 300 to be electrically coupled to second contact portions (which, in turn are connected to a HUD system, for example) using a chip flipping process rather than wire bonding. Some of the advantages of chip flipping in the context of an LCOS SLM have already been described above.

However, the LCOS 300 is not suitable for a flip chip bonding process. This is because the light modulating region 410 of the LCOS 300 (shown in FIG. 4) must be addressable by light. In other words, the light modulating region 410 must be able to receive and modulate light and to reflect that modulated light (the LCOS SLM 300 operates in a reflective mode). But the LCOS 300 comprises electrical connection region 412 comprising first contact portions 414 on the same side that light modulating region 410 addresses light. In other words, the LCOS 300 is optically and electrically addressed from the same side or face (which is the face shown in FIG. 4). Thus, if the LCOS 300 were electrically connected to second contact portions of a carrier/connector, the light modulating region 410 would face the carrier/connector and so would no longer be able to be optically addressable.

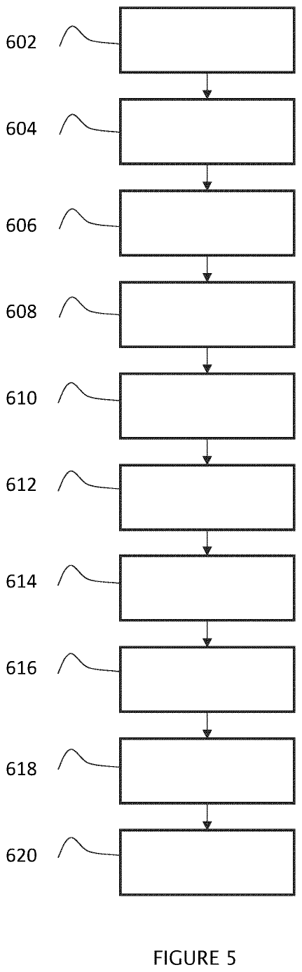

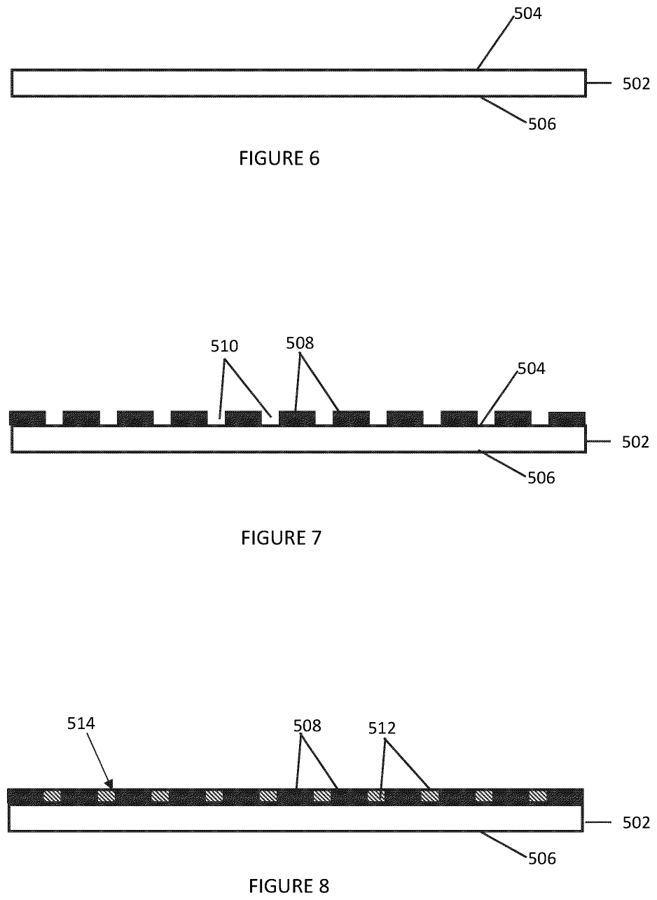

The inventor has devised a new and unconventional method of fabricating an LCOS SLM which is synergistic for flip chipping, as will be described herein in relation to the flow chart of FIG. 5 and FIGS. 6 to 14. Each of FIGS. 6 to 14 is cross-sectional side view showing the constituent parts of the LCOS SLM as it is manufactured. As the skilled reader will recognise, the method of fabrication according to the present disclosure results in the layers of the LCOS SLM being fabricated in a completely different order to that of LCOS 300. This results in a completely different (and unconventional fabrication) method in order to achieve an LCOS SLM that is synergistic for flip chip bonding.

FIG. 5 is a flow chart showing a method of manufacturing a liquid crystal on silicon spatial light modulator package.

Step 602 of the method comprises the provision of a substrate 502 which, in this example, comprises or consists of silicon and takes the form of a planar wafer of silicon on which the rest of the LCOS is fabricated and is shown in FIG. 6. The substrate 502 comprises a first major surface 504 and a second major surface 506 on an opposite side of the substrate to the first major surface. In this example, the planar wafer of silicon has a generally rectangular shape.

Step 604 of the method comprises depositing an array of electrodes 508 on to the first major surface 504 of the substate 502. This is shown in FIG. 7. In this example, each electrode 508 comprises or consists of aluminium and is deposited in such a way as to form a planar electrode. In some examples, each electrode 508 has a planar, square shape. Adjacent electrodes 508 of the array are spatially separated such that a gap 510 exists between each adjacent electrode 508. Because FIG. 7 is a cross-sectional view of the substrate 502, only one dimension of the electrodes 508 is shown. However, it should be clear that the array of electrodes will generally be a two dimensional array. The two-dimensional array of electrodes 508 may substantially cover the first major surface 504 of the substrate 502. The electrodes 508 may be referred to as forming an electrode layer. Each electrode 508 will form/define a pixel of the SLM when it has been fabricated.

Step 606 of the method is an optional step and is shown in FIG. 8. Step 606 comprises infilling the gaps 510 between electrodes 508 with an electrically insulating material or dielectric material 512 such as silicon dioxide. The dielectric material 512 infills the gaps 510 so as to form a continuous, smooth and planar top surface 514 for further processing.

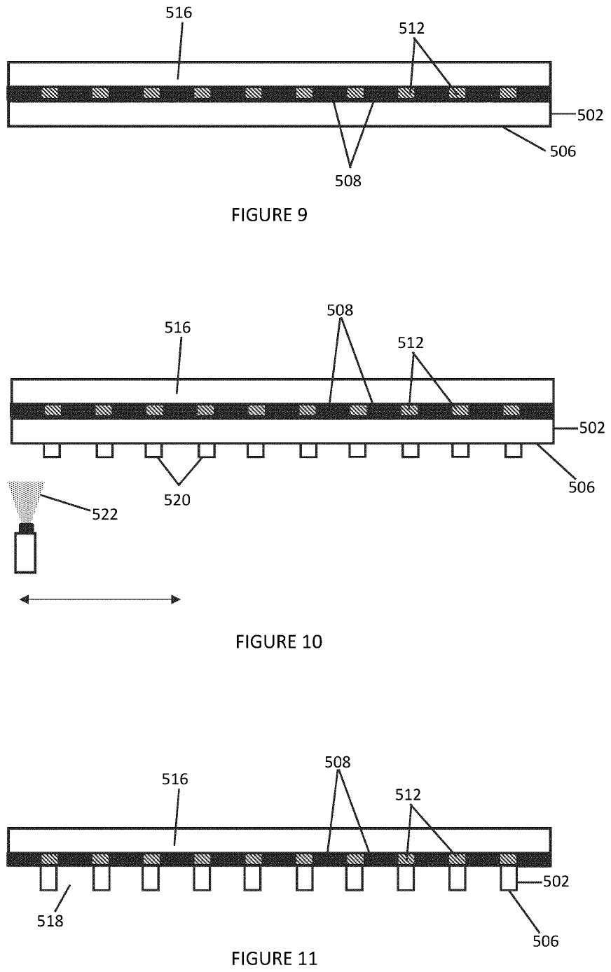

Step 608 of the method is shown in FIG. 9. Step 608 comprises forming a silicon stack 516 on the top surface 514. The silicon stack 516 is fabricated using complementary metal-oxide-semiconductor fabrication (CMOS) processes which will be familiar to the skilled reader. In particular CMOS processes are used to fabricate a silicon stack 516 containing the electric circuitry (such as signal lines, gate lines and transistors) needed to address the electrodes 508. The electric circuitry is buried in the silicon stack and, in this example, is above the array of electrodes 508 (but the substrate will be flipped, as described herein, and so the circuitry will be below the array of electrodes 508 in the fabricated LCOS). As in the LCOS SLM 300, this arrangement of burying the circuitry above/below the array of electrodes 508 allows for a high fill factor. The electric circuitry is not specifically shown in FIG. 9, but the silicon stack 516 is.

Step 610 of the method is shown in FIGS. 10 and 11. Step 610 comprises etching the substrate 502 from the second major surface 506. Specifically, in this example, step 510 comprises etching channels 518 in the substrate 510. Each channel 518 extends through the full thickness of the substrate 510 (i.e. material is removed from the second major surface 506 until channel 518 has reached the electrode layer). The channels 518 are positioned in coordination with the electrodes 508. In other words, the size (e.g. width and depth), shape and position of each channel 518 corresponds to the size, shape and position of the respective electrode. Thus, the etching exposes each of the electrodes 508 such that each electrode 508 is optically addressable from an opposite side of the LCOS SLM to that of the silicon stack 516 and associated circuitry (which electrically addresses the electrodes 508). The skilled reader will be familiar with appropriate techniques for masking and etching the substrate 502 (e.g. silicon wafer) to form the channels 518. In this example, a mask 520 made of a photoresist or other suitable material is applied to the second major surface 506 of the substrate 502. Specifically, the photoresist is used to cover regions of the substrate 502 that are not to be removed. In examples, the masked substrate 502 is then exposed to appropriate etching gases/plasma 522 (from the second major surface side of the substrate) as shown in FIG. 10. Exposed regions of the second major surface 506 of the substrate (i.e. not covered in photoresist) will be removed at a predictable rate while the masked regions will be protected. Once the etching process has finished, the mask 520 is removed, leaving the channels 518 and exposed electrodes 508, as shown in FIG. 11.

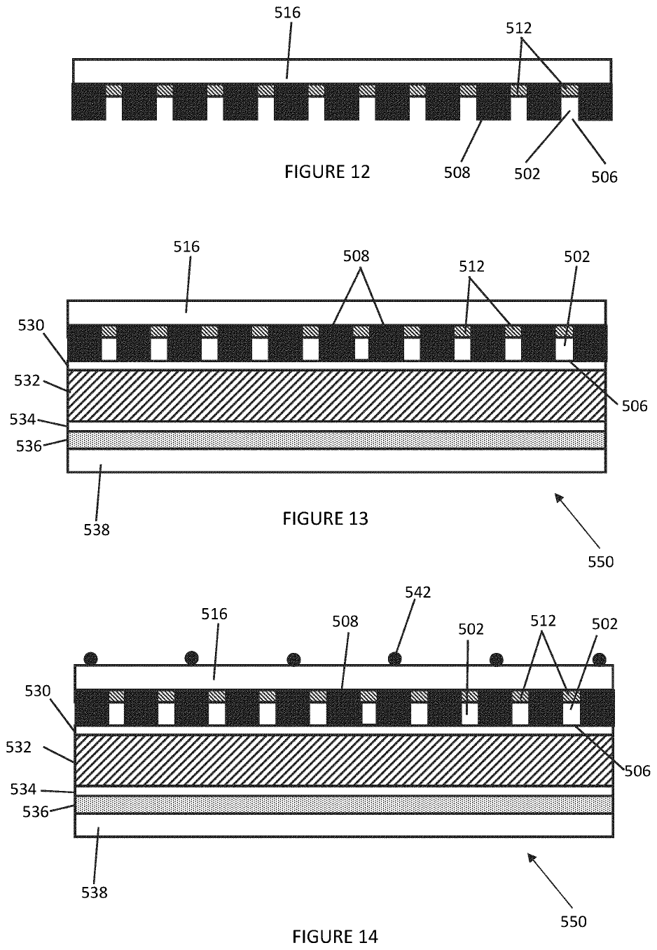

Some examples of the method include optional step 612 which is shown in FIG. 12. Optional step 612 comprises infilling each of the channels 518 with a conductive material. In some examples, the conductive material used to infill the channels 518 is the same as the conductive material of the electrodes 508. So, in some examples, aluminium is used to infill the channels 518. In this way, the electrodes 508 may be effectively considered to be extended by the infilling process. In some examples, the exposed surface 524 of the (extended) electrodes 508 is polished to ensure that the exposed surface 524 is planar and forms a highly reflective surface or mirror. The exposed surface 524 is optically addressable (i.e. is suitable for receiving/addressing light received from the second side of the SLM LCOS). The extended electrodes 508 fill the channels 518. The result of this is the extended electrodes 508 and remaining portions 526 of the substrate 502 form a continuous, planar surface.

In other examples (not illustrated), the etching of the substrate 502 comprises removing the substrate in its entirety. In such examples, the electrodes 508 are exposed, and so too is the dielectric material 512 infill between the electrodes 508. In such examples, the electrodes 508 may be polished and the (polished) electrodes 508 and dielectric material 512 may form a continuous, planar surface.

Step 614 of the method is shown in FIG. 13. Step 614 comprises fabricating a layered liquid crystal device 528 on the continuous, planar surface formed by the extended electrodes 508 and substrate 502 or on the continuous, planar surface formed by the electrodes and dielectric material (the former is shown in FIG. 13). This comprises: a) forming a first alignment layer 530 on said continuous, planar surface, for example using a thin-film process; d) applying/forming a liquid crystal layer 532 on the first alignment layer 530; e) forming a second alignment layer 534 on the liquid crystal layer 532, for example using a thin-film process; f) depositing a transparent electrode 536 on the second alignment layer 534 and g) sealing the liquid crystal layer using a transparent layer 538 on the transparent electrode 536 and, optionally, with seals around the perimeter of the LCOS SLM.

After step 614, an LCOS SLM 550 has been manufactured/fabricated that is electrically addressable and optically addressable from opposing sides. Thus, the LCOS SLM 550 is suitable for flip chip bonding to a package substrate comprising electrical contact portions for electrical coupling to corresponding electric contact portions on the LCOS SLM 550.

Steps 602, 604, optional step 606, and 608 should be performed in the order described. Steps 610 and 612 should be performed in that order, but these ordered steps could be performed immediately after step 608 in some examples or immediately after step 612 in some examples.

In examples, the method further comprises flip chip bonding the LCOS SLM 550 to a package substrate 560. This will be described in relation to steps 616 to 620, and FIGS. 14 to 17, herein.

Step 616 of the method is shown in FIG. 14. Step 616 of the method comprises forming a ball grid array of solder balls or bumps 542 on silicon stack 516, according to any suitable method as the skilled person will be familiar. Specifically, in this example, each solder ball or bump 542 is attached to/electrically coupled to an electrical contact portion of the silicon stack 516 (not shown in the drawings). As the skilled reader will appreciate, the electrical contact portions of the silicon stack 516 are formed to allow the electrical circuitry of the silicon stack 516 to be electrically coupled to a HUD system, for example. FIG. 14 shows the solder balls or bumps 542 as forming a regular array (having a regular periodicity). This is merely exemplary. Solder balls or bumps 542 may be positioned in whatever density, quantity and pattern as required by the electrical circuitry of the silicon stack 516.

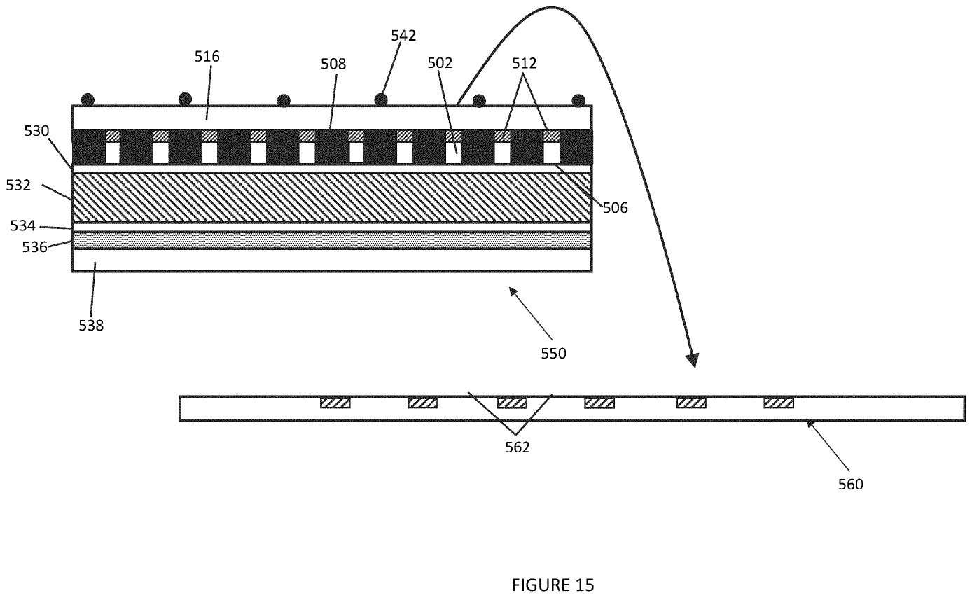

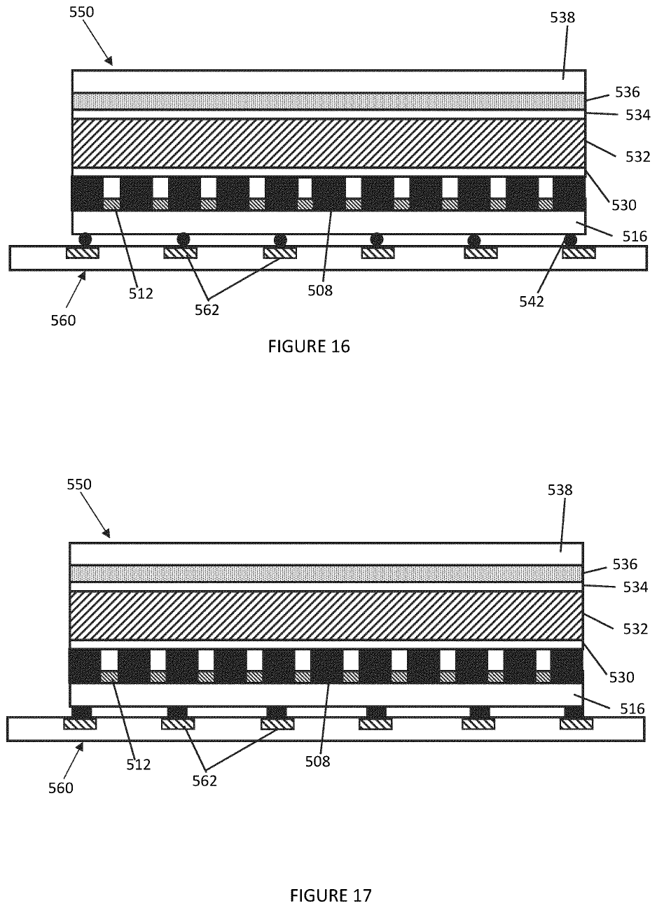

Step 618 of the method is shown in FIGS. 15 and 16. Step 618 comprises flipping the LCOS SLM 550 and aligning the solder balls/bumps 542 to respective electrical contact portions 562 of the package substrate 560.

Step 620 of the method is shown in FIG. 17. Step 620 of the method comprises causing the solder balls/bumps 542 to reflow, for example by the application of heat, and then letting the solder of the solder balls/bumps re-solidify such that the solder forms electrical connections between the LCOS SLM 550 and the package substrate 560.

In the example in accordance with the method described above, a substrate 502 in the form of a silicon wafer is selected. Optical addressability is achieved by etching the substrate 502 from a second major surface. In other examples, the silicon substrate 502 may be replaced with a substantially transparent substrate, such as a sapphire substrate comprising or consisting of synthetic sapphire. In such examples, there may be no need to etch channels 518 or tunnels into the substrate to expose the electrodes 508 (and to optionally infill those channels 518 or tunnels). Instead, the electrodes 508 may be exposed to light receivable from the second major surface 506 by virtue of the selection a substantially transparent substrate. Light may be transmitted through the substrate from the second major surface, for example. Thus, in such examples,

### ADDITIONAL FEATURES

Embodiments refer to an electrically-activated LCOS spatial light modulator by way of example only. The teachings of the present disclosure may equally be implemented on any spatial light modulator capable of displaying a computer-generated hologram in accordance with the present disclosure such as any electrically-activated SLMs, optically-activated SLM, digital micromirror device or microelectromechanical device, for example.

Examples describe illuminating the SLM with visible light but the skilled person will understand that the light sources and SLM may equally be used to direct infrared or ultraviolet light, for example, as disclosed herein. For example, the skilled person will be aware of techniques for converting infrared and ultraviolet light into visible light for the purpose of providing the information to a user. For example, the present disclosure extends to using phosphors and/or quantum dot technology for this purpose.

Some embodiments describe 2D holographic reconstructions by way of example only. In other embodiments, the holographic reconstruction is a 3D holographic reconstruction. That is, in some embodiments, each computer-generated hologram forms a 3D holographic reconstruction.

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

1. A method of manufacturing a spatial light modulator package for a spatial light modulator, the method comprising:
forming an electrically addressable portion on a first major surface of a substrate, the electrically addressable portion comprising:
an electrode layer comprising a plurality of electrodes formed on the first major surface of the substrate; and
a semiconductor structure electrically connected or connectable to the electrode layer;
forming an optically addressable portion by etching the substrate from a second major surface thereof to expose the plurality of electrodes, the second major surface opposing the first major surface; and
flip chip bonding the electrically addressable portion to a package substrate.

2. The method of claim 1, wherein the substrate comprises a substantially opaque material.

3. The method of claim 1, wherein the optically addressable portion and the electrically addressable portion are arranged such that the spatial light modulator is electrically addressable from a first side of the substrate and optically addressable from a second side of the substrate, opposite to the first side.

4. The method of claim 1, further comprising fabricating the semiconductor structure on the electrode layer.

5. The method of claim 4, wherein fabricating the semiconductor structure comprises a complementary metal-oxide-semiconductor fabrication (CMOS) process.

6. The method of claim 1, wherein the electrically addressable portion comprises a plurality of solder portions electrically connected or connectable to the semiconductor structure.

7. The method of claim 6, further comprising forming the plurality of solder portions.

8. The method of claim 7, wherein forming the plurality of solder portions comprises forming a ball grid array.

9. The method of claim 6, wherein flip chip bonding comprises aligning each solder portion with an electrical contact portion of the package substrate

10. The method of claim 6, wherein flip chip bonding step comprises reflowing the plurality of solder portions.

11. The method of claim 6, wherein the method comprises forming the electrode layer and then fabricating the semiconductor structure and then forming the plurality of solder portions.

12. The method of claim 1, wherein the electrically addressable portion has a substantially layered structure.

13. The method of claim 1, wherein each of the electrode of the electrode layer is formed of a reflective material.

14. The method of claim 1, wherein etching the substrate comprises forming a plurality of channels in the substrate, each channel exposing an electrode.

15. The method of claim 14, wherein the method further comprises applying a mask to the second major surface of the substrate prior to etching the substrate, wherein the mask comprises a plurality of apertures, each aperture being arranged to form one of the channels during etching.

16. The method of claim 14, wherein the method further comprises infilling each channel with an electrically conductive material.

17. The method of claim 1, wherein etching the substrate comprises substantially completely removing the substrate.

18. A method of flip chip bonding a spatial light modulator to a package substrate, the method comprising:
aligning a plurality of solder portions of a spatial light modulator with electrical contact portions of a package substrate; and
reflowing the solder portions;
wherein the spatial light modulator comprises an electrically addressable portion comprising the solder portions and an optically addressable portion; and
wherein the optically addressable portion is arranged to receive light on an opposite side of the spatial light modulator to the electrically addressable portion.

19. A spatial light modulator package manufactured according to a method comprising:
forming an electrically addressable portion on a first major surface of a substrate, the electrically addressable portion comprising:
an electrode layer comprising a plurality of electrodes formed on the first major surface of the substrate; and
a semiconductor structure electrically connected or connectable to the electrode layer;
forming an optically addressable portion by etching the substrate from a second major surface thereof to expose the plurality of electrodes, the second major surface opposing the first major surface; and
flip chip bonding the electrically addressable portion to a package substrate.

20. A system comprising a spatial light modulator, wherein the spatial light modulator comprises:
a substrate comprising first and second opposing major surfaces;
an electrically addressable portion on the first major surface, the electrically addressable portion comprising an electrode layer comprising a plurality of electrodes, and a semiconductor structure arranged such that the electrode layer is between the substrate and the semiconductor structure; and
an optically addressable portion on the second major surface, the optically addressable portion comprising a plurality of cells for liquid crystal;
wherein the substrate comprises a plurality of channels from the first major surface to the second major surface, each channel corresponding to a respective electrode.

21. The system of claim 20, wherein individual electrodes of the plurality of electrodes extend into the respective channel in the substrate.

22. The system of claim 20, wherein the spatial light modulator is arranged to be electrically addressable from a first side and optically addressable from a second side.

23. The system of claim 20, further comprising:
a spatial light modulator package comprising the spatial light modulator attached to a package substrate.
